(19) United States
(12) Patent Application Publication
(10) Pub. No.: US 2024/0196166 A1
(43) Pub. Date: Jun. 13, 2024

(54) NETWORK PERFORMANCE MONITORING METHOD AND SYSTEM FOR IMPLEMENTING

(71) Applicant: Rakuten Mobile, Inc., Tokyo (JP)

(72) Inventors: Nitin PAL, Madhya Pradesh (IN); Shivchandra PATHAK, Madhya Pradesh (IN); Pravin MUKATI, Madhya Pradesh (IN); Goutam AGRAWAL, Madhya Pradesh (IN)

(21) Appl. No.: 17/757,775

(22) PCT Filed: Apr. 25, 2022
(86) PCT No.: PCT/US2022/026105

§ 371 Date: Jun. 21, 2022

(51) Int. Cl. H04W 4/024; G06F 11/36; H04M 1/72406; H04W 24/02

(52) U.S. Cl. CPC H04W 4/024; G06F 11/3692; H04M 1/72406; H04W 24/02

(57) ABSTRACT

A system for monitoring network performance includes a non-transitory computer readable medium. The non-transitory computer readable medium is configured to store instructions thereon. The system further includes a processor connected to the non-transitory computer readable medium. The processor is configured to receive an inquiry from a user having access to a mobile device. The processor is configured to determine whether the system is able to access an application on the mobile device. The processor is configured to transmit a request to implement a performance test to the application in response to determining the system is able to access the application. The processor is configured to receive results of the performance test. The processor is configured to provide a recommendation for addressing the inquiry from the user based on the received results of the performance test.

### FIELD

This application relates to a network performance monitoring method and a system for implementing the network performance monitoring.

### BACKGROUND

Telecommunication networks provide coverage maps and advertise network performance in order to entice customers to use a specific network. If a customer selects a telecommunication network and the performance of the telecommunication network is different from the advertised coverage or performance, the customer is likely to become dissatisfied with the telecommunication network. In such a situation the customer is likely to contact a service representative of the telecommunication network in order to try to resolve issues with the coverage or performance experienced by the customer. In some approaches, once the service representative is contacted, the service representative will ask the customer to perform various tests on a device controlled by the customer.

### SUMMARY

An aspect of this description relates to a system for monitoring network performance. The system includes a non-transitory computer readable medium, wherein the non-transitory computer readable medium is configured to store instructions thereon. The system further includes a processor connected to the non-transitory computer readable medium. The processor is configured to execute the instructions for receiving an inquiry from a user having access to a mobile device. The processor is further configured to execute the instructions for determining whether the system is able to access an application on the mobile device. The processor is further configured to execute the instructions for transmitting a request to implement a performance test to the application in response to determining the system is able to access the application. The processor is further configured to execute the instructions for receiving results of the performance test. The processor is further configured to execute the instructions for providing a recommendation for addressing the inquiry from the user based on the received results of the performance test. In some embodiments, the processor is further configured to execute the instructions for transmitting a request to install the application to the mobile device in response to determining the system is unable to access the application. In some embodiments, the processor is further configured to execute the instructions for receiving registration information from the application in response to transmitting the request to install the application. In some embodiments, the processor is further configured to execute the instructions for generating the request to install the application, wherein the request to install the application is configured to cause an alert to appear on the mobile device. In some embodiments, the processor is further configured to execute instructions for transmitting the request to implement the performance test in response to receiving the registration information. In some embodiments, the processor is further configured to execute the instructions for generating the request to implement the performance test, wherein the request to implement the performance test is configured to cause the mobile device to display an alert to the user in response to receiving the request. In some embodiments, the processor is further configured to execute the instructions for transmitting a repair request to maintenance personnel based on the received results of the performance test. In some embodiments, the processor is further configured to execute the instructions for providing the recommendation including causing a map to appear on the mobile device, wherein the map includes a location of a store or repair shop. In some embodiments, the processor is further configured to execute the instructions for providing the recommendation including directions to a store or repair shop.

An aspect of this description relates to a method of monitoring performance of a network. The method includes receiving an inquiry from a user having access to a mobile device. The method further includes determining whether the system is able to access an application on the mobile device. The method further includes transmitting a request to implement a performance test to the application in response to determining the system is able to access the application. The method further includes receiving results of the performance test. The method further includes providing a recommendation for addressing the inquiry from the user based on the received results of the performance test. In some embodiments, the method further includes transmitting a request to install the application to the mobile device in response to determining the system is unable to access the application. In some embodiments, the method further includes receiving registration information from the application in response to transmitting the request to install the application. In some embodiments, the method further includes generating the request to install the application, wherein the request to install the application is configured to cause an alert to appear on the mobile device. In some embodiments, transmitting the request to implement the performance test comprises transmitting the request to implement the performance test in response to receiving the registration information. In some embodiments, the method further includes generating the request to implement the performance test, wherein the request to implement the performance test is configured to cause the mobile device to display an alert to the user in response to receiving the request. In some embodiments, providing the recommendation includes providing the recommendation for causing a map to appear on the mobile device, wherein the map includes a location of a store or repair shop. In some embodiments, providing the recommendation includes providing the recommendation comprising directions to a store or repair shop. In some embodiments, the method further includes transmitting a repair request to maintenance personnel based on the received results of the performance test.

An aspect of this description relates to a non-transitory computer readable medium storing instructions thereon. The instructions, when executed by a processor, are configured to cause the processor to receive an inquiry from a user having access to a mobile device. The instructions, when executed by the processor, are further configured to cause the processor to determine whether the system is able to access an application on the mobile device. The instructions, when executed by the processor, are further configured to cause the processor to transmit a request to implement a performance test to the application in response to determining the system is able to access the application. The instructions, when executed by the processor, are further configured to cause the processor to receive results of the performance test. The instructions, when executed by the processor, are further configured to cause the processor to provide a recommendation for addressing the inquiry from the user based on the received results of the performance test. In some embodiments, the instructions are configured to cause the processor to execute transmit a request to install the application to the mobile device in response to determining the system is unable to access the application.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a system for monitoring network performance in accordance with some embodiments.

FIG. 2 is a schematic diagram of a system for monitoring network performance in accordance with some embodiments.

FIG. 3 is a schematic diagram of a system for monitoring network performance in accordance with some embodiments.

FIG. 4 is a diagram of a method of monitoring network performance in accordance with some embodiments.

FIG. 5 is a diagram of a method of monitoring network performance in accordance with some embodiments.

FIG. 6 is a diagram of a method of monitoring network performance in accordance with some embodiments.

FIG. 7 is a diagram of a method of monitoring network performance in accordance with some embodiments.

FIG. 8 is a diagram of a system for monitoring network performance in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A customer contacting a service representative regarding an inquiry about coverage or performance of a telecommunication network often already has some amount of dissatisfaction. Prolonged conversations and requesting the customer to perform operations on the mobile device during an interaction with the service representative is likely to increase the degree of dissatisfaction on the part of the customer. Also, customers often have difficulty in accurately explaining a problem or complaint, so the service representative has difficulty in properly identifying a source of an inquiry. Ineffective resolution attempts often cause an increase in customer dissatisfaction.

In order to reduce or eliminate effort on the part of the customer during an interaction with the service representative, the current disclosure includes an ability to access information about the mobile device directly through an application installed on the mobile device. Based on the information from the application, the service representative is able to provide solutions or recommendations to the customer in an expedited fashion. In a situation where the application is not currently installed on the mobile device, a push request is able to be sent to the mobile device for installing the application in order to reduce effort on the part of the customer for installing the application. As a result, a level of dissatisfaction on the part of the customer is reduced or eliminated.

By remotely requesting that the installed application provide information regarding the mobile device, the service representative is able to retrieve information, such as location or key performance indicators (KPIs), for the mobile device without additional effort on the part of the customer. Using this information, the service representative is able to recommend potential remedies to the customer or direct the customer to a nearby service location. In some embodiments, the KPIs include upload speeds, download speeds, latency, jitter, or other suitable performance criteria. In some embodiments, the customer is prompted on the mobile device to authorize transmission of the KPI information to the service representative. In some embodiments, the KPI information is transmitted to the service representative automatically without customer interaction.

In some embodiments, the instruction for installing the application on the mobile device is transmitted to the mobile device using short message service (SMS) or multimedia messaging service (MMS) including a link or other suitable instructions. In some embodiments, the instruction is configured to cause the mobile device to automatically prompt the customer to authorize installation of the application. By providing the customer with a way to easily install the application, the customer is not requested to search through an application on-line store for the application to be installed. This helps to avoid or minimize frustration on the part of the customer.

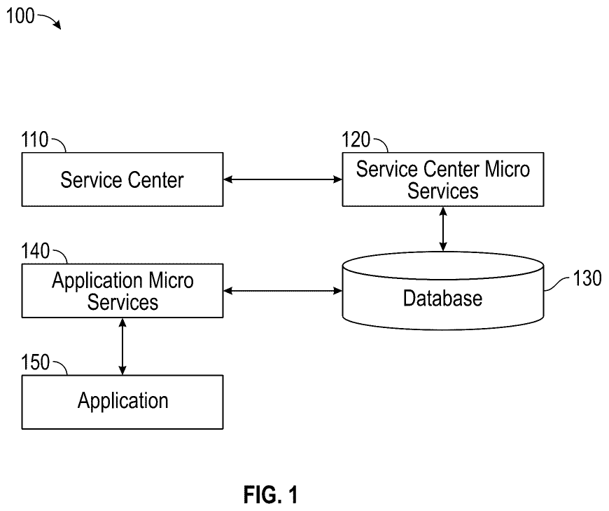

FIG. 1 is a block diagram of a system 100 for monitoring network performance in accordance with some embodiments. The system 100 includes a service center 110. The service center 110 is configured to receive inquiries from customers. The system 100 further includes service center micro services 120. A micro service includes autonomous units configured to address individual functions. Micro services interact to provide overall functionality of the service center 110. The use of micro services helps to provide granular security and customization for the overall service center 110. Information utilized by or generated by the service center micro services is stored in a database 130. The database 130 is able to communicate with application micro services 140 that are implemented on a mobile device, such as a mobile phone. The application micro services 140 are used by an application 150 on the mobile device to implement an overall functionality of the application 150.

In operation, the system 100 would utilize the service center micro services 120 and the application micro services 140 to determine performance or location of the mobile device on which the application 150 is executed. A mobile device user contacts the service center 110. At the service center 110, a service representative would access the service center micro services 120 to determine whether the mobile device controlled by the mobile device user has the application 150 installed thereon. In some embodiments, this information is determined based on information stored in the database 130. In some embodiments, this information is determined based on exchange of data between the service center micro services 120 and the application micro services 140. In some embodiments, the exchange of data is performed wirelessly. In some embodiments, the exchange of data is performed via a wired connection.

In response to a determination that the application 150 is installed on the mobile device, the service center micro services 120 is configured to communicate with the application micro services 140 through the database 130 to obtain performance or location data related to the mobile device. In response to a determination that the application 150 is not installed on the mobile device, the service center micro services 120 is configured to transmit information to the mobile device through the database 130 for instructing the mobile device user how to install the application 150. Once the application 150 is installed on the mobile device, the service center micro services 120 and the application micro services 140 are able to exchange data to determine the performance or location of the mobile device. In some embodiments, application micro services 140 are configured to exchange information within the application 150 in order to obtain the performance or location information for the mobile device.

The information related to the performance or location of the mobile device is stored in the database 130. In some embodiments, the database 130 is configured to store information related to the mobile device, such as model number, previous performance, or location history, etc., to assist the service representative in answering inquiries from the mobile device user.

In response to receiving the performance or location information from the application micro services 140, the service center micro services 120 are configured to provide information for reducing or resolving an inquiry from the mobile device user to the service center 110. In some embodiments, the information for reducing or resolving the inquiry is stored in the database 130 in a manner correlated to a type of problem experienced by the mobile device user and the performance or location information obtained by the service center micro services 120. In some embodiments, the information for reducing or resolving the inquiry is generated by the service center micro services 120 by exchanging of data between various service center micro services 120 with in the service center 110. Once the service center 110 has the information for reducing or resolving the inquiry the information is conveyed to the mobile device user. In some embodiments, the information is conveyed to the mobile device user verbally from a service representative. In some embodiments, the information is automatically transmitted to the mobile device user, such as through SMS, through the application 150, through an automatically generated alert on the mobile device, or another suitable manner.

In some embodiments, the information for reducing or resolving the inquiry includes directing the mobile device user to a nearby store. In such a situation, the information is configured to cause the mobile device to automatically display a map or directions to a nearby store, in some embodiments. In some embodiments, the information for reducing or resolving the inquiry includes instructions for implementing some operation on the mobile device, such as a restart operation, reset operation, or another suitable operation. In such a situation, the information is configured to automatically cause the mobile device to implement the operation, in some embodiments. In some embodiments, in such a situation, the information is configured to cause the mobile device to automatically display instructions for implementing the operation to the mobile device user.

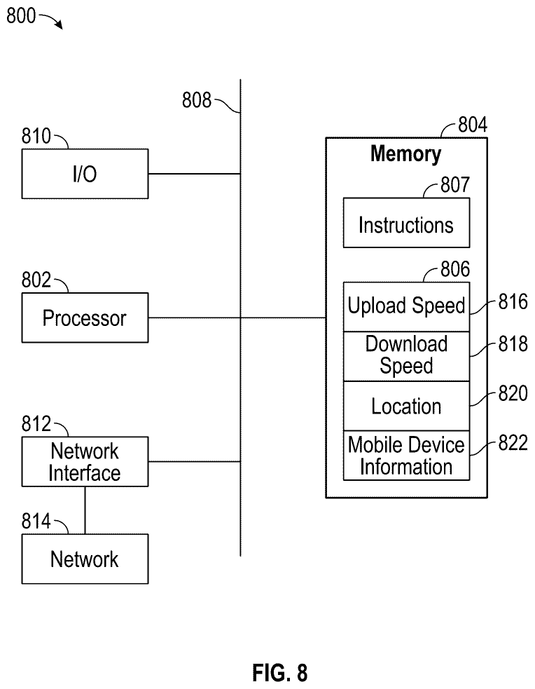

In some embodiments, the service center 110, the service center micro services 120, or the database 130 is implemented using the system 800 (FIG. 8) described in detail below.

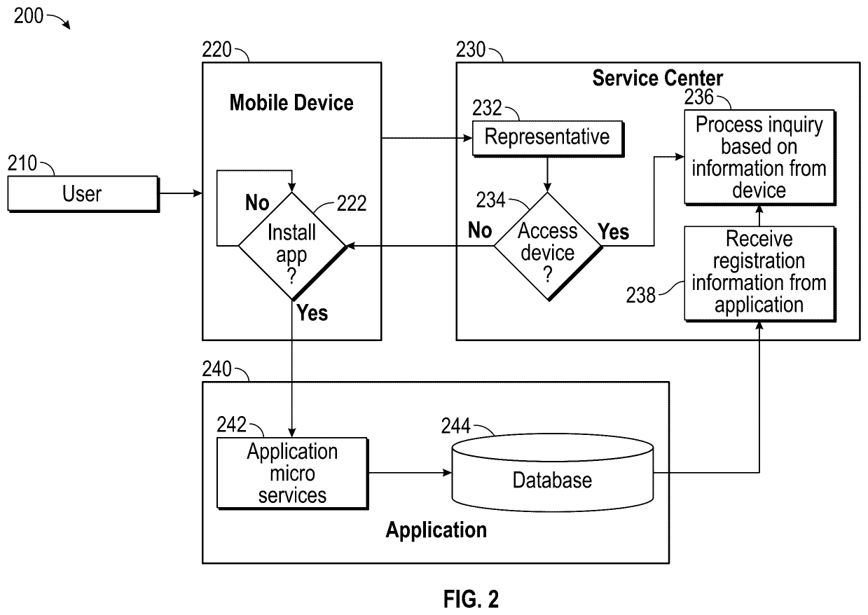

FIG. 2 is a schematic diagram of a system 200 for monitoring network performance in accordance with some embodiments. In some embodiments, the system 200 is also able to determine a location of a mobile device 220. In some embodiments, the system 200 is implemented using the system 100 (FIG. 1). In some embodiments, at least a portion of the system 200 is implemented using the system 800 (FIG. 8). In some embodiments, the system 200 is implemented using a system other than the system 100 (FIG. 1) or the system 800 (FIG. 8).

The system 200 includes a user 210 that is able to access a mobile device 220. In some embodiments, the mobile device 220 includes a mobile phone. In some embodiments, the mobile device 220 includes a tablet. In some embodiments, the mobile device includes a different mobile device, such as a vehicle communication system, a global positioning system (GPS), smart glasses, smart clothing, or another suitable mobile device. In some embodiments, the user 210 owns the mobile device 220. In some embodiments, the user 210 is able to access the mobile device 220, but does not own the mobile device 220.

The user 210 is able to use the mobile device 220 to issue an inquiry to a service center 230. In some embodiments, the user 210 uses the mobile device 220 to send the inquiry to the service center 230 verbally. In some embodiments, the user 210 uses the mobile device 220 to send the inquiry to the service center 230 using SMS, an application 240, or other communication protocols. In some embodiments, the inquiry is transmitted wirelessly. In some embodiments, the inquiry is transmitted via a wired connection. In some embodiments, the inquiry includes a complaint about a service provided to the mobile device 220. For example, in some instances, the user 210 is inquiring about a difference between an advertised performance for a telecommunication network on which the mobile device 220 communicates and the experience perceived by the user 210. Examples for differences in performance include differences in upload (UL) or download (DL) speeds, lack of coverage in a particular location, or other performance criteria. Performance metrics are measured using key performance indicators (KPIs), in some instances. Determining the KPIs for the mobile device 220 helps to determine whether telecommunication network is performing at an advertised level for the mobile device 220.

The inquiry is received by a representative 232 at the service center 230. In some embodiments, the representative 232 is a human. In some embodiments, the representative 232 is an automated representative. In some embodiments, functions of the representative 232 are performed partially by an automated representative and partially by a human.

Upon receiving the inquiry, the representative 232 attempts to access the application 240 on the mobile device 220. Accessing the application 240 allows the representative to collect KPI information about the performance or location of the mobile device 220.

At operation 234 within the service center 234, a determination is made regarding whether the representative is able to access the application 240 on the mobile device 220. In response to the representative 232 being unable to access the application 240 on the mobile device 220, the service center 230 transmits a request to the mobile device 220 to install the application 240. In some embodiments, the request is transmitted wirelessly. In some embodiments, the request is transmitted via a wired connection. In some embodiments, the request is transmitted using SMS. In some embodiments, the request is configured to cause an alert to be displayed on the mobile device 220 automatically. In some embodiments, the alert is an audio or visual alert. In some embodiments, the alert is configured to prompt the user 210 to provide authorization for the installation of the application 240. In some embodiments, the request includes a link selectable by the user 210 to download and install the application 240 on the mobile device 220. In response to the representative 232 being able to access the application 240 on the mobile device 220, the service center 230 is configured to receive information related to KPIs for the mobile device 220. The service center 230 is able to process the inquiry based on the information received in operation 236.

In some embodiments, processing the information in operation 236 includes the representative 232 providing verbal instructions to the user 210 regarding operations to reduce or resolve the inquiry. In some embodiments, processing the information in operation 236 includes the representative 232 providing information to the user 210 regarding an on-going repair process for the telecommunication network. In some embodiments, processing the information in the operation 236 includes the service center 230 generating a repair instruction for maintenance personnel to repair or replace a component within the telecommunication network. In some embodiments, the repair instruction is generated automatically and transmitted to the maintenance personnel automatically from the service center 230. In some embodiments, processing the information in operation 236 includes the representative 232 informing the user 210 about the repair request being initiated. In some embodiments, processing the information in operation 236 includes providing information to the user 210 related to operations to be performed by the user 210 to reduce or resolve the inquiry. In some embodiments, processing the information in operation 236 includes instructing the user 210 to take the mobile device 220 to a store or repair shop. In some instances, the service center 230 is configured to provide instructions to the mobile device 220 to automatically display directions or a map to the store or repair shop. In some embodiments, processing the information in operation 236 includes providing instructions to the mobile device 220 to remotely cause an operation, such as a restart or reset operation to be automatically implemented on the mobile device 220.

In response to receiving the request from the service center 230, the mobile device 220 is configured to receive instructions from the user 210 regarding whether to install the application 240. In some embodiments, the instructions from the user 210 include selecting a link, an icon, or other object on the mobile device 220 to approve installation of the application 240. In some embodiments, the instructions from the user 210 include verbal confirmation. In some embodiments, the instructions from the user 210 are authenticated, such as using facial recognition, input of a passcode, fingerprint recognition, or other suitable authentication processes, prior to installation of the application 240. In response to receiving instructions in operation 222 to install the application 240, the mobile device 220 begins the process of downloading and installing the application 240. Once the application 240 is downloaded and installed, the user 210 is able to access the application micro services 242 to input relevant information related to the user 210 or the mobile device 220 into the application. In some embodiments, at least some of the relevant information is automatically populated in the application micro services 242 based on information within the mobile device 220 accessible by the application 240.

In response to failing to receive instructions to install the application 240, the mobile device 220 waits for a predetermined amount of time before terminating an operation requesting approval for installation of the application 240. The predetermined amount of time is set based on an amount of time deemed appropriate by the service center 230 for the user 210 to make an informed decision for installing the application 240. In some embodiments, the predetermined amount of time ranges from about 30 seconds to about 2 minutes. In some embodiments once the predetermined amount of time has passed the mobile device 220 transmits information to the service center 230 indicating refusal to install the application 240. In some embodiments, the user 210 will inform the representative 232 of the refusal to install the application 240. In some embodiments, the user 210 will actively decline installation of the application 240. In response to receiving a refusal to install the application 240, the representative 232 or the service center 230 is able to continue interacting with the user 210 but will not be able to remotely access information directly from the application 240 on the mobile device 220.

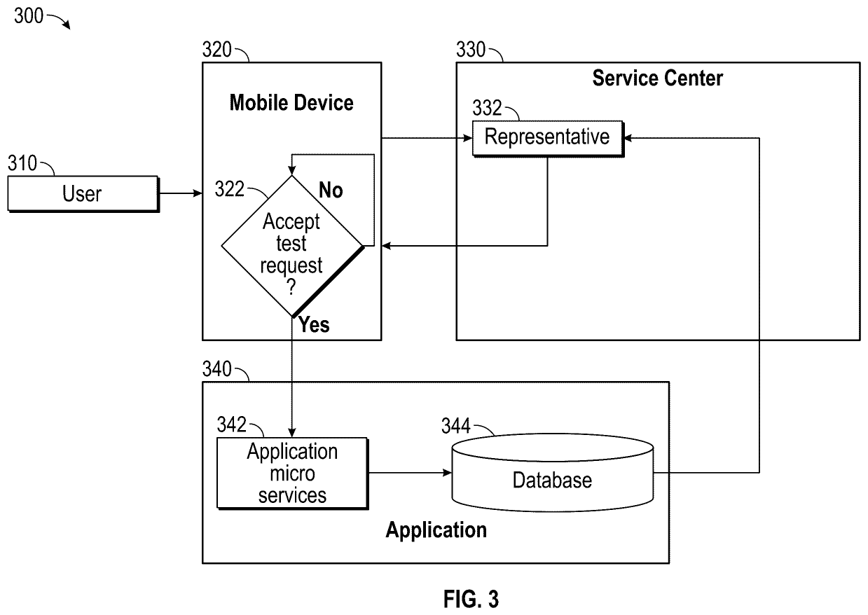

Once the relevant information is entered into the application micro services 242, the relevant information is stored in a database 244 accessible by the application 240. The database 244 is on the mobile device 220 and is accessible by other applications on the mobile device 220 other than the application 240. In some embodiments, the database 244 includes a partition dedicated to the application 240. In some embodiments, once the relevant information is stored in the database 244, the application micro services 242 initiate collection of KPIs from the mobile device 220. Additional details of the collection of KPIs from the mobile device are discussed with respect to system 300 (FIG. 3) below.

The mobile device 220 is configured to transmit the relevant information from the database 244 to the service center 230. In some embodiments, the relevant information is transmitted wirelessly. In some embodiments, the relevant information is transmitted via a wired connection. In response to receiving the relevant information, the service center 230 is configured to, in operation 238, to receive the information as registration information from the application 240 for registering the mobile device 220 and the application 240 in a database accessible by the service center 230. In some embodiments, the database includes a local memory structure. In some embodiments, the database includes a remote memory structure.

Using the system 200, the service center 230 is able to collect KPI information related to the mobile device 220 with reduced if any increase in frustration by the user 210. In some instances, expectations by the user 210 are greater than the advertised performance for the telecommunication network. In some instances, the telecommunication network is experiencing a temporary poor performance. In some instances, the user 210 inquiry is a first indication of a problem with the telecommunication network. In some instances, the mobile device 220 is faulty or is performing for a reason unrelated to the telecommunication network. Determining which of these reasons, or a different reason, provides a basis for the inquiry from the user 210 is often difficult because the user 210 is not experienced in operating the mobile device 220 or does not know about temporary problems with the telecommunication network. In order to help reduce or resolve the inquiry from the user 210, the service center 230 relies on the KPI information from the mobile device 220. However, obtaining the KPI information from the mobile device 220 is often difficult for most users 210. In order to help reduce or avoid direct user 210 interaction to obtain the KPI data, the service center 230 is able to communicate with the application 240 installed on the mobile device 220. Using this communication approach, the user 210 is not frustrated by being asked to perform multiple operations on the mobile device 220. In addition, the service center 230 is able to accurately obtain information without a risk of the user 210 inadvertently providing erroneous information. Obtaining reliable information helps to maximize the effectiveness of the advice or solutions provided to the user 210 by the service center 230.

FIG. 3 is a schematic diagram of a system 300 for monitoring network performance in accordance with some embodiments. In some embodiments, the system 300 is also able to determine a location of a mobile device 320. In some embodiments, the system 300 is implemented using the system 100 (FIG. 1). In some embodiments, at least a portion of the system 300 is implemented using the system 800 (FIG. 8). In some embodiments, the system 300 is implemented using a system other than the system 100 (FIG. 1) or the system 800 (FIG. 8). In some embodiments, the system 300 is a same system as the system 200 (FIG. 2) and just implements different functionality from the system 200 (FIG. 2). In some embodiments, the user 310 is a same as the user 210 (FIG. 2). In some embodiments, the mobile device 320 is a same as the mobile device 220 (FIG. 2). In some embodiments, the service center 330 is a same as the service center 230 (FIG. 2). In some embodiments, the representative 332 is a same as the representative 232 (FIG. 2). In some embodiments, the application 340 is a same as the application 240 (FIG. 2). In some embodiments, the application micro services 342 is a same as the application micro services 232 (FIG. 2). In some embodiments, the database 344 is a same as the database 244 (FIG. 2).

In contrast with the system 200 (FIG. 2), the system 300 is operating based on the service center 330 being able to access the application 340. That is, the application 340 is already installed on the mobile device 320 and registration information for the application 340 is already stored in a database accessible by the service center 330.

In response to receiving an inquiry from the user 310, the representative 332 instructs the service center 330 to send a request for information to the mobile device 320. In some embodiments, the inquiry from the user 310 is a same inquiry as that associated with the system 200 (FIG. 2) described above. In some embodiments, the inquiry from the user 310 is different from the inquiry associated with the system 200 (FIG. 2) described above. In some embodiments, the request is transmitted wirelessly. In some embodiments, the request is transmitted via a wired connection.

In response to receiving the request, the mobile device 320 is configured to automatically generate an alert for the user 310 to approve the access to the application 340 by the service center 330. In some embodiments, the approval from the user 310 include selecting a link, an icon, or other object on the mobile device 320 to approve access to the application 340. In some embodiments, the approval from the user 310 include verbal confirmation. In some embodiments, the approval from the user 310 is authenticated, such as using facial recognition, input of a passcode, fingerprint recognition, or other suitable authentication processes, prior to granting access to the application 340.

Once the access to the application 340 is approved, the application micro services 342 collect KPIs for the mobile device 320. In some embodiments, the KPIs include UL speed, DL speed, location information, or other suitable KPIs. The KPIs are stored in the database 344 to be transmitted to the service center 330. In some embodiments, the KPIs are transmitted to the service center 330 wirelessly. In some embodiments, the KPIs are transmitted to the service center 330 via a wired connection.

In response to failing to receive approval to access the application 340, the mobile device 320 waits for a predetermined amount of time before terminating an operation requesting approval for access to the application 340. The predetermined amount of time is set based on an amount of time deemed appropriate by the service center 330 for the user 310 to make an informed decision for permitting access to the application 340. In some embodiments, the predetermined amount of time ranges from about 30 seconds to about 2 minutes. In some embodiments once the predetermined amount of time has passed the mobile device 320 transmits information to the service center 330 indicating refusal of access to the application 340. In some embodiments, the user 310 will inform the representative 332 of the refusal to permit access to the application 340. In some embodiments, the user 310 will actively decline access to the application 340. In response to receiving a refusal of access to the application 340, the representative 332 or the service center 330 is able to continue interacting with the user 310 but will not be able to remotely access information directly from the application 340 on the mobile device 320.

In some embodiments, the operation 322 is bypassed and the service center 330 is able to directly access the application 340 without approval by the user 310. For example, in some embodiments, the user 310 is able to grant the service center 330 access to the application 340 during registration of the application 340. The pre-authorization of access to the application 340 reduces an amount of actions on the part of the user 310 during the interaction with the service center 330. The reduced amount of actions helps to avoid or reduce increases in frustration on the part of the user 310.

Based on the received KPIs from the application 340, the representative 332 is able to provide recommendations or solutions to the user 310 for addressing the inquiry. In some embodiments, the recommendation or solution from the representative 332 includes remotely performing an operation on the mobile device 320. In some embodiments, a separate authentication or approval operation, similar to that described above with respect to operation 322, is performed to permit the representative 332 to remotely perform an operation on the mobile device 320. In some embodiments, the recommendation or solution includes directing the user 310 to take the mobile device to a store or repair shop. In some embodiments, the service center 330 is able to provide instructions to the mobile device 320 to automatically display a map or directions to the store or repair shop. In some embodiments, the service center 330 is able to provide contact information for the store or repair shop. In some embodiments, the recommendation or solutions include instructions for operations to be performed by the user 310. In some embodiments, the instructions are provided by SMS, a link to a website or video for implementing the instructions, or other suitable information to allow the user 310 to implement the requested operation. In some embodiments, the recommendation or solution is provided to the user 310 verbally. In some embodiments, the service center 330 is configured to automatically generate the recommendation or solutions based on the received KPIs. In some embodiments, the recommendation or solutions are generated based on a decision tree using the KPIs. In some embodiments, the recommendation or solutions are generated based on a train neural network (NN) using the KPIs. In some embodiments, the recommendation or solutions are transmitted wirelessly. In some embodiments, the recommendation or solutions are transmitted via a wired connection.

In some embodiments, the representative 332 provides information to the user 310 regarding an on-going repair process for the telecommunication network. In some embodiments, the service center 330 generates a repair instruction for maintenance personnel to repair or replace a component within the telecommunication network. In some embodiments, the repair instruction is generated automatically and transmitted to the maintenance personnel automatically from the service center 330. In some embodiments, the representative 332 informs the user 310 about the repair request being initiated.

Using the system 300, the service center 330 is able to collect KPI information related to the mobile device 320 with reduced if any increase in frustration by the user 310. Using this communication approach, the user 310 is not frustrated by being asked to perform multiple operations on the mobile device 320. In addition, the service center 330 is able to accurately obtain information without a risk of the user 310 inadvertently providing erroneous information. Obtaining reliable information helps to maximize the effectiveness of the advice or solutions provided to the user 310 by the service center 330.

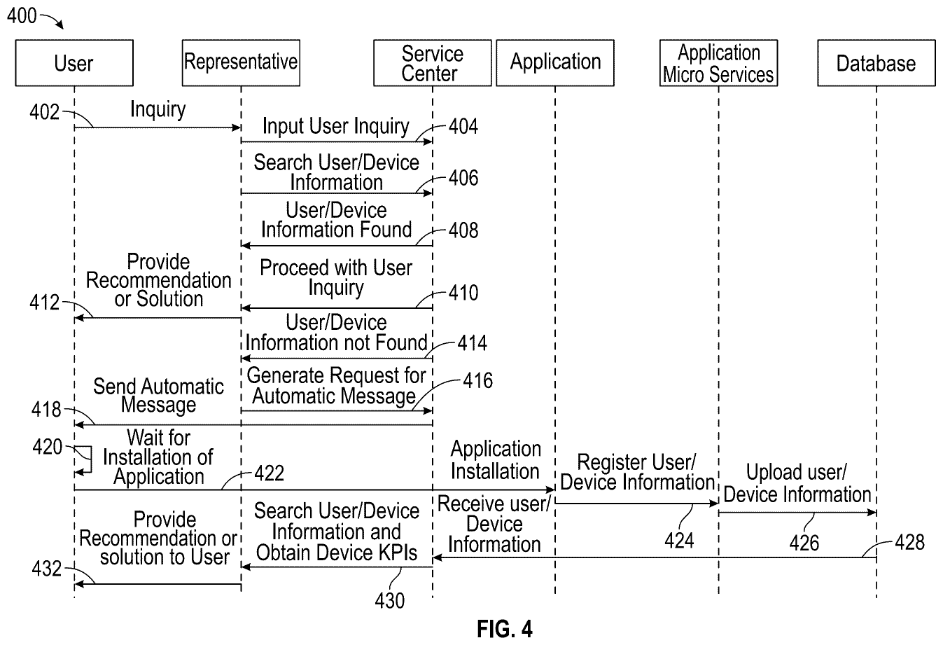

FIG. 4 is a diagram of a method 400 of monitoring network performance in accordance with some embodiments. In some embodiments, the method 400 is implemented by one or more of the system 100 (FIG. 1), the system 200 (FIG. 2), or the system 300 (FIG. 3). In some embodiments, the method 400 is implemented by a system other than the system 100 (FIG. 1), the system 200 (FIG. 2), or the system 300 (FIG. 3). The method 400 includes operations performed by various actors or components of a system. For ease of understanding, the names of these actors or components are similar to those described above. One of ordinary skill in the art would understand that in some embodiments all of the actors and components are similar to those described above; and that in some embodiments at least one of the actor or components is different from those described above. Each of the operations and transfers of information and data described with respect to the method 400 are independently capable of wireless or wired transmission.

In operation 402, the user sends an inquiry to the representative. In some embodiments, the inquiry includes a complaint about performance or service coverage of a telecommunication network.

In operation 404, the representative inputs the user inquiry into a database accessible by a service center.

In operation 406, the representative searches the database accessible by the service center for information for the user or a mobile device accessible by the user. In some embodiments, the information includes user identification information. In some embodiments, the information includes device identification information. In some embodiments, the information includes data regarding whether an application is installed on the mobile device.

In operation 408, the database accessible by the service center provides information related to the user or mobile device to the representative. In some embodiments, the information includes KPI information received from the mobile device.

In operation 410, the service center provides instructions for the representative to proceed with processing of the inquiry from the user. In some embodiments, the instructions include instructions for remotely performing an operation on the mobile device. In some embodiments, a separate authentication or approval operation, similar to that described above with respect to operation 322 (FIG. 3), is used to permit the representative to remotely perform an operation on the mobile device. In some embodiments, the instructions include directing the user to take the mobile device to a store or repair shop. In some embodiments, the instructions include instructions for operations to be performed by the user. In some embodiments, the service center is configured to automatically generate the recommendation or solutions based on the received KPIs. In some embodiments, the recommendation or solutions are generated based on a decision tree using the KPIs. In some embodiments, the recommendation or solutions are generated based on a train NN using the KPIs.

In operation 412, the representative provides the instructions to the user. In some embodiments, the representative provides the instructions to the mobile device to automatically display a map or directions to the store or repair shop. In some embodiments, the representative provides contact information for the store or repair shop. In some embodiments, the instructions are provided by SMS, a link to a website or video for implementing the instructions, or other suitable information to allow the user to implement the requested operation. In some embodiments, the instructions are provided to the user verbally.

In operation 414, the database accessible by the service center provides a notification to the representative that information related to the user or mobile device was not found. One of ordinary skill in the art would understand that in some embodiments, if operation 412 is performed, then operations 414-432 are omitted from an implementation of the method 400. That is, if the user or device information is available in the database accessible by the service center, the method 400 terminates after providing the recommendation or solution to the user, in some embodiments. However, if the user or device information is not found in the database accessible by the service center, then the method 400 proceeds to additional operations for installing an application on the mobile device.

In operation 416, the representative requests that the service center generate an automatic message to send to the user. The automatic message includes information for downloading and installing an application to provide KPI information from the mobile device.

In operation 418, the service center transmits the automatic message to the user. That automatic message includes information for installing the application on the mobile device. In some embodiments, the automatic message includes a link, an icon, or other selectable object to initiate installation of the application.

In operation 420, the mobile device waits for the user to authorize installation of the application. In some embodiments, the operation 420 continues until the user authorizes installation of the application. In some embodiments, in response to failing to receive instructions to install the application, the mobile device waits for a predetermined amount of time before terminating an operation requesting approval for installation of the application. In some embodiments, the predetermined amount of time ranges from about 30 seconds to about 2 minutes.

In operation 422, the application is installed. The application is downloaded in response to the authorization from the user and installed on the mobile device.

In operation 424, the application receives registration information for the user or mobile device. The registration information is received by the application micro services for registering the application with the service center.

In operation 426, the registration information is uploaded to a database. In some embodiments, the database is the database accessible by the service center. In some embodiments, the database is stored on the mobile device and the registration information is transferred to the service center upon receipt of a request from the service center.

In operation 428, the registration information is transferred to the service center.

In operation 430, the representative is able to search for the user information or the mobile device information in the registration information. The representative if able to retrieve KPI information based on the information from the application micro services. In some embodiments, the operation 430 is similar to the operation 410.

In operation 432, the representative provides the recommendation or solution for the inquiry to the user. In some embodiments, the operation 432 is similar to the operation 412.

Using the method 400, the service center is able to collect KPI information related to the mobile device with reduced if any increase in frustration by the user. In order to help reduce or resolve the inquiry from the user, the service center relies on the KPI information from the mobile device. In order to help reduce or avoid direct user interaction to obtain the KPI data, the service center is able to communicate with the application installed on the mobile device. Using this communication approach, the user is not frustrated by being asked to perform multiple operations on the mobile device. In addition, the service center is able to accurately obtain information without a risk of the user inadvertently providing erroneous information. Obtaining reliable information helps to maximize the effectiveness of the advice or solutions provided to the user by the service center.

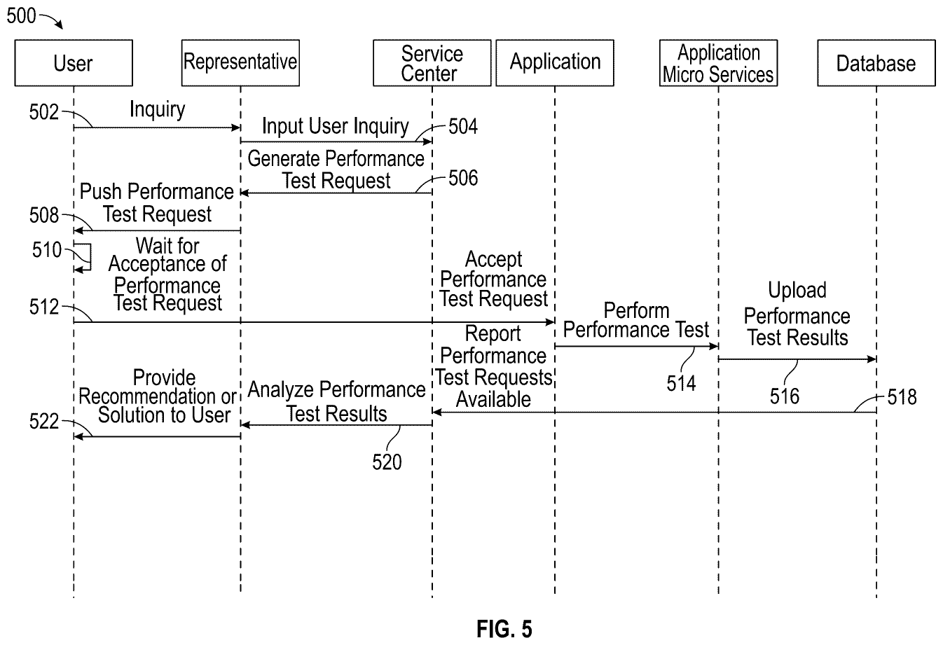

FIG. 5 is a diagram of a method of monitoring network performance in accordance with some embodiments. In some embodiments, the method 500 is implemented by one or more of the system 100 (FIG. 1), the system 200 (FIG. 2), or the system 300 (FIG. 3). In some embodiments, the method 500 is implemented by a system other than the system 100 (FIG. 1), the system 200 (FIG. 2), or the system 300 (FIG. 3). The method 500 includes operations performed by various actors or components of a system. For ease of understanding, the names of these actors or components are similar to those described above. One of ordinary skill in the art would understand that in some embodiments all of the actors and components are similar to those described above; and that in some embodiments at least one of the actor or components is different from those described above. Each of the operations and transfers of information and data described with respect to the method 500 are independently capable of wireless or wired transmission.

In operation 502, the user sends an inquiry to the representative. In some embodiments, the inquiry includes a complaint about performance or service coverage of a telecommunication network.

In operation 504, the representative inputs the user inquiry into a database accessible by a service center.

In operation 506, the service center instructs the representative to send a performance test request to the mobile device accessible by the user. In some embodiments, the performance test is configured to message at least one of UL speed or DL speed for the mobile device. In some embodiments, the operation 506 is omitted and the service center automatically sends the performance test request to the mobile device accessible by the user without interaction by the representative.

In operation 508, the performance test request is sent to the mobile device accessible by the user. In some embodiments, the request includes an alert for the user to approve the access to the application by the service center.

In operation 510, the mobile device waits for the user to authorize access to the application to implement the performance test. In some embodiments, the approval from the user includes selecting a link, an icon, or other object on the mobile device to approve access to the application. In some embodiments, the approval from the user includes verbal confirmation. In some embodiments, the approval from the user is authenticated, such as using facial recognition, input of a passcode, fingerprint recognition, or other suitable authentication processes, prior to granting access to the application.

In some embodiments, in response to failing to receive approval to access the application, the mobile device waits for a predetermined amount of time before terminating an operation requesting approval for access to the application. In some embodiments, the predetermined amount of time ranges from about 30 seconds to about 2 minutes. In some embodiments once the predetermined amount of time has passed the mobile device transmits information to the service center indicating refusal of access to the application.

In some embodiments, the operation 510 is bypassed and the service center is able to directly access the application without approval by the user. For example, in some embodiments, the user is able to grant the service center access to the application 340 during registration of the application.

In operation 512, the user accepts the performance test and the service center is granted access to the application.

In operation 514, the application micro services collect KPIs for the mobile device. In some embodiments, the KPIs include UL speed, DL speed, location information, or other suitable KPIs.

In operation 516, the KPIs obtained during the performance test are stored in the database to be transmitted to the service center.

In operation 518, the performance test result KPIs are transmitted to the service center.

In operation 520, the service center analyzes the performance test results. Based on the received KPIs from the application micro services, the representative is able to provide recommendations or solutions to the user for addressing the inquiry. In some embodiments, the service center is configured to automatically generate the recommendation or solutions based on the received KPIs. In some embodiments, the recommendation or solutions are generated based on a decision tree using the KPIs. In some embodiments, the recommendation or solutions are generated based on a train neural network (NN) using the KPIs.

In operation 522, the representative provides the recommendation or solution to the user. In some embodiments, the recommendation or solution from the representative includes remotely performing an operation on the mobile device. In some embodiments, a separate authentication or approval operation is performed to permit the representative to remotely perform an operation on the mobile device. In some embodiments, the recommendation or solution includes directing the user to take the mobile device to a store or repair shop. In some embodiments, the service center is able to provide instructions to the mobile device to automatically display a map or directions to the store or repair shop. In some embodiments, the service center is able to provide contact information for the store or repair shop. In some embodiments, the recommendation or solutions include instructions for operations to be performed by the user. In some embodiments, the instructions are provided by SMS, a link to a website or video for implementing the instructions, or other suitable information to allow the user to implement the requested operation. In some embodiments, the recommendation or solution is provided to the user verbally.

In some embodiments, the representative provides information to the user 310 regarding an on-going repair process for the telecommunication network. In some embodiments, the service center generates a repair instruction for maintenance personnel to repair or replace a component within the telecommunication network. In some embodiments, the repair instruction is generated automatically and transmitted to the maintenance personnel automatically from the service center. In some embodiments, the representative informs the user about the repair request being initiated.

Using the method 500, the service center is able to collect KPI information related to the mobile device with reduced if any increase in frustration by the user. Using this communication approach, the user is not frustrated by being asked to perform multiple operations on the mobile device. In addition, the service center is able to accurately obtain information without a risk of the user inadvertently providing erroneous information. Obtaining reliable information helps to maximize the effectiveness of the advice or solutions provided to the user by the service center.

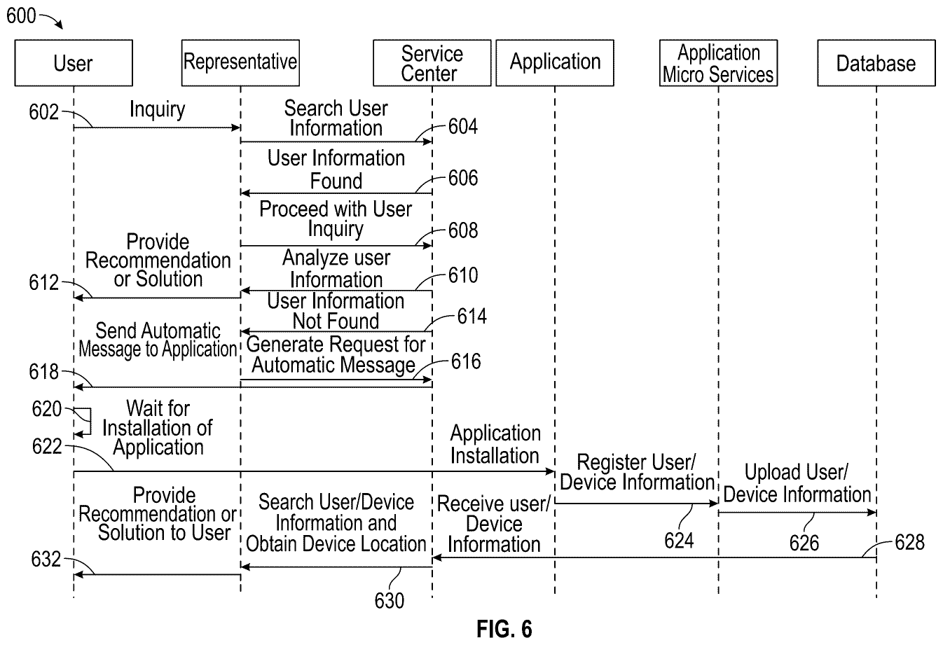

FIG. 6 is a diagram of a method 600 of monitoring network performance in accordance with some embodiments. In some embodiments, the method 600 is implemented by one or more of the system 100 (FIG. 1), the system 200 (FIG. 2), or the system 300 (FIG. 3). In some embodiments, the method 600 is implemented by a system other than the system 100 (FIG. 1), the system 200 (FIG. 2), or the system 300 (FIG. 3). The method 600 includes operations performed by various actors or components of a system. For ease of understanding, the names of these actors or components are similar to those described above. One of ordinary skill in the art would understand that in some embodiments all of the actors and components are similar to those described above; and that in some embodiments at least one of the actor or components is different from those described above. Each of the operations and transfers of information and data described with respect to the method 600 are independently capable of wireless or wired transmission.

The method 600 is similar to the method 400 (FIG. 4). In comparison with the method 400 (FIG. 4), the method 600 is related to obtaining a location of the mobile device. In some embodiments, the method 400 (FIG. 4) and the method 600 are performed simultaneously to provide the service center with both performance and location information for the mobile device. For the sake of brevity, the operation of the method 600 are not explained in detail.

Obtaining the location of the mobile device helps to determine whether the mobile device is currently in a location where the telecommunication network is advertised as providing coverage. The location of the mobile device also provides information related to a type of service available at the mobile device location. For example, a user that is accustomed to having a high speed service, such as fifth generation (5G) or long term evolution (LTE), and is now in a location that offers only slower speed service, such a fourth generation (4G), could inquiry regarding poor service. By being able to determine a location of the mobile device, the representative is able to explain to a user the level of service offered at the current location of the mobile device.

In addition, if the service experienced by the user is below an advertised level of service, the service center is able to accurately determine which eNB is services the location of the mobile device. This allows the service center to generate a repair instruction for maintenance personnel. By knowing the precise location of the mobile device, the repair instruction is able to be generated with higher efficiency. The increased efficiency with respect to repair instructions helps to maximize performance of the telecommunication network and maintain a high level of customer satisfaction.

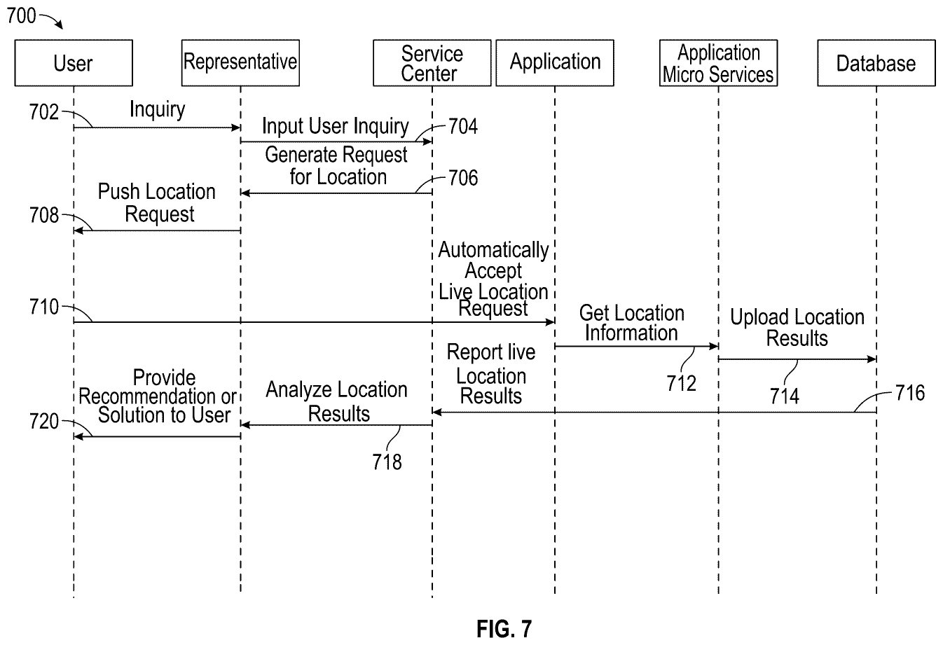

FIG. 7 is a diagram of a method 700 of monitoring network performance in accordance with some embodiments. In some embodiments, the method 700 is implemented by one or more of the system 100 (FIG. 1), the system 200 (FIG. 2), or the system 300 (FIG. 3). In some embodiments, the method 700 is implemented by a system other than the system 100 (FIG. 1), the system 200 (FIG. 2), or the system 300 (FIG. 3). The method 700 includes operations performed by various actors or components of a system. For ease of understanding, the names of these actors or components are similar to those described above. One of ordinary skill in the art would understand that in some embodiments all of the actors and components are similar to those described above; and that in some embodiments at least one of the actor or components is different from those described above. Each of the operations and transfers of information and data described with respect to the method 700 are independently capable of wireless or wired transmission.

The method 700 is similar to the method 500 (FIG. 5). In comparison with the method 500 (FIG. 5), the method 700 is related to obtaining a location of the mobile device. In some embodiments, the method 500 (FIG. 5) and the method 700 are performed simultaneously to provide the service center with both performance and location information for the mobile device. For the sake of brevity, the operation of the method 700 are not explained in detail. As described above with respect to the method 600 (FIG. 6), the method 700 helps to determine whether a level of service at the location of the mobile device is meeting advertised specifications. The method 700 also helps to improve efficiency is repairing the telecommunication network in response to a situation where the level of service at the location of the mobile device is below the advertised specifications.

FIG. 8 is a diagram of a system 800 for monitoring network performance in accordance with some embodiments. System 800 includes a hardware processor 802 and a non-transitory, computer readable storage medium 804 encoded with, i.e., storing, the computer program 1 code 806, i.e., a set of executable instructions. Computer readable storage medium 804 is also encoded with instructions 807 for interfacing with external devices. The processor 802 is electrically coupled to the computer readable storage medium 804 via a bus 808. The processor 802 is also electrically coupled to an I/O interface 810 by bus 808. A network interface 812 is also electrically connected to the processor 802 via bus 808. Network interface 812 is connected to a network 814, so that processor 802 and computer readable storage medium 804 are capable of connecting to external elements via network 814. The processor 802 is configured to execute the computer program code 806 encoded in the computer readable storage medium 804 in order to cause system 800 to be usable for performing a portion or all of the operations as described in the system 100 (FIG. 1), the system 200 (FIG. 2), the system 300 (FIG. 3), the method 400 (FIG. 4), or method 500 (FIG. 5).

In some embodiments, the processor 802 is a central processing unit (CPU), a multi-processor, a distributed processing system, an application specific integrated circuit (ASIC), and/or a suitable processing unit.

In some embodiments, the computer readable storage medium 804 is an electronic, magnetic, optical, electromagnetic, infrared, and/or a semiconductor system (or apparatus or device). For example, the computer readable storage medium 804 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 804 includes a compact disk-read only memory (CD-ROM), a compact disk-read/write (CD-R/W), and/or a digital video disc (DVD).

In some embodiments, the storage medium 804 stores the computer program code 806 configured to cause system 800 to perform a portion or all of the operations as described in the system 100 (FIG. 1), the system 200 (FIG. 2), the system 300 (FIG. 3), the method 400 (FIG. 4), or method 500 (FIG. 5). In some embodiments, the storage medium 804 also stores information used for performing a portion or all of the operations as described in the system 100 (FIG. 1), the system 200 (FIG. 2), the system 300 (FIG. 3), the method 400 (FIG. 4), or method 500 (FIG. 5) as well as information generated during performing a portion or all of the operations as described in the system 100 (FIG. 1), the system 200 (FIG. 2), the system 300 (FIG. 3), the method 400 (FIG. 4), or method 500 (FIG. 5), such as an upload speed parameter 816, a download speed parameter 818, a location parameter 820, a mobile device information parameter 822, and/or a set of executable instructions to perform a portion or all of the operations as described in the system 100 (FIG. 1), the system 200 (FIG. 2), the system 300 (FIG. 3), the method 400 (FIG. 4), or method 500 (FIG. 5).

In some embodiments, the storage medium 804 stores instructions 807 for interfacing with external devices. The instructions 807 enable processor 802 to generate instructions readable by the external devices to effectively implement a portion or all of the operations as described in the system 100 (FIG. 1), the system 200 (FIG. 2), the system 300 (FIG. 3), the method 400 (FIG. 4), or method 500 (FIG. 5).

System 800 includes I/O interface 810. I/O interface 810 is coupled to external circuitry. In some embodiments, I/O interface 810 includes a keyboard, keypad, mouse, trackball, trackpad, and/or cursor direction keys for communicating information and commands to processor 802.

System 800 also includes network interface 812 coupled to the processor 802. Network interface 812 allows system 800 to communicate with network 814, to which one or more other computer systems are connected. Network interface 812 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in the system 100 (FIG. 1), the system 200 (FIG. 2), the system 300 (FIG. 3), the method 400 (FIG. 4), or method 500 (FIG. 5) is implemented in two or more systems 800, and information such as upload speed, download speed, location, and mobile device information are exchanged between different systems 800 via network 814.

An aspect of this description relates to a system for monitoring network performance. The system includes a non-transitory computer readable medium, wherein the non-transitory computer readable medium is configured to store instructions thereon. The system further includes a processor connected to the non-transitory computer readable medium. The processor is configured to execute the instructions for receiving an inquiry from a user having access to a mobile device. The processor is further configured to execute the instructions for determining whether the system is able to access an application on the mobile device. The processor is further configured to execute the instructions for transmitting a request to implement a performance test to the application in response to determining the system is able to access the application. The processor is further configured to execute the instructions for receiving results of the performance test. The processor is further configured to execute the instructions for providing a recommendation for addressing the inquiry from the user based on the received results of the performance test. In some embodiments, the processor is further configured to execute the instructions for transmitting a request to install the application to the mobile device in response to determining the system is unable to access the application. In some embodiments, the processor is further configured to execute the instructions for receiving registration information from the application in response to transmitting the request to install the application. In some embodiments, the processor is further configured to execute the instructions for generating the request to install the application, wherein the request to install the application is configured to cause an alert to appear on the mobile device. In some embodiments, the processor is further configured to execute instructions for transmitting the request to implement the performance test in response to receiving the registration information. In some embodiments, the processor is further configured to execute the instructions for generating the request to implement the performance test, wherein the request to implement the performance test is configured to cause the mobile device to display an alert to the user in response to receiving the request. In some embodiments, the processor is further configured to execute the instructions for providing the recommendation including causing a map to appear on the mobile device, wherein the map includes a location of a store or repair shop. In some embodiments, the processor is further configured to execute the instructions for providing the recommendation including directions to a store or repair shop. In some embodiments, the processor is further configured to execute the instructions for transmitting a repair request to maintenance personnel based on the received results of the performance test.

An aspect of this description relates to a method of monitoring performance of a network. The method includes receiving an inquiry from a user having access to a mobile device. The method further includes determining whether the system is able to access an application on the mobile device. The method further includes transmitting a request to implement a performance test to the application in response to determining the system is able to access the application. The method further includes receiving results of the performance test. The method further includes providing a recommendation for addressing the inquiry from the user based on the received results of the performance test. In some embodiments, the method further includes transmitting a request to install the application to the mobile device in response to determining the system is unable to access the application. In some embodiments, the method further includes receiving registration information from the application in response to transmitting the request to install the application. In some embodiments, the method further includes generating the request to install the application, wherein the request to install the application is configured to cause an alert to appear on the mobile device. In some embodiments, transmitting the request to implement the performance test comprises transmitting the request to implement the performance test in response to receiving the registration information. In some embodiments, the method further includes generating the request to implement the performance test, wherein the request to implement the performance test is configured to cause the mobile device to display an alert to the user in response to receiving the request. In some embodiments, providing the recommendation includes providing the recommendation for causing a map to appear on the mobile device, wherein the map includes a location of a store or repair shop. In some embodiments, providing the recommendation includes providing the recommendation comprising directions to a store or repair shop. In some embodiments, the method further includes transmitting a repair request to maintenance personnel based on the received results of the performance test.

An aspect of this description relates to a non-transitory computer readable medium storing instructions thereon. The instructions, when executed by a processor, are configured to cause the processor to receive an inquiry from a user having access to a mobile device. The instructions, when executed by the processor, are further configured to cause the processor to determine whether the system is able to access an application on the mobile device. The instructions, when executed by the processor, are further configured to cause the processor to transmit a request to implement a performance test to the application in response to determining the system is able to access the application. The instructions, when executed by the processor, are further configured to cause the processor to receive results of the performance test. The instructions, when executed by the processor, are further configured to cause the processor to provide a recommendation for addressing the inquiry from the user based on the received results of the performance test. In some embodiments, the instructions are configured to cause the processor to execute transmit a request to install the application to the mobile device in response to determining the system is unable to access the application.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for monitoring network performance, the system comprising:
a non-transitory computer readable medium, wherein the non-transitory computer readable medium is configured to store instructions thereon; and
a processor connected to the non-transitory computer readable medium, wherein the processor is configured to execute the instructions for:
receiving an inquiry from a user having access to a mobile device;
determining whether the system is able to access an application on the mobile device;
transmitting a request to implement a performance test to the application in response to determining the system is able to access the application;
receiving results of the performance test; and
providing a recommendation for addressing the inquiry from the user based on the received results of the performance test.

2. The system according to claim 1, wherein the processor is further configured to execute the instructions for transmitting a request to install the application to the mobile device in response to determining the system is unable to access the application.

3. The system according to claim 2, wherein the processor is further configured to execute the instructions for receiving registration information from the application in response to transmitting the request to install the application.

4. The system according to claim 2, wherein the processor is further configured to execute the instructions for generating the request to install the application, wherein the request to install the application is configured to cause an alert to appear on the mobile device.

5. The system according to claim 3, wherein the processor is further configured to execute instructions for transmitting the request to implement the performance test in response to receiving the registration information.

6. The system according to claim 1, wherein the processor is further configured to execute the instructions for generating the request to implement the performance test, wherein the request to implement the performance test is configured to cause the mobile device to display an alert to the user in response to receiving the request.

7. The system according to claim 1, wherein the processor is further configured to execute the instructions for providing the recommendation including causing a map to appear on the mobile device, wherein the map includes a location of a store or repair shop.

8. The system according to claim 1, wherein the processor is further configured to execute the instructions for providing the recommendation including directions to a store or repair shop.

9. The system according to claim 1, wherein the processor is further configured to execute the instructions for transmitting a repair request to maintenance personnel based on the received results of the performance test.

10. A method of monitoring performance of a network, the method comprising:
receiving an inquiry from a user having access to a mobile device;
determining whether the system is able to access an application on the mobile device;
transmitting a request to implement a performance test to the application in response to determining the system is able to access the application;
receiving results of the performance test; and
providing a recommendation for addressing the inquiry from the user based on the received results of the performance test.

11. The method according to claim 10, further comprising transmitting a request to install the application to the mobile device in response to determining the system is unable to access the application.

12. The method according to claim 11, further comprising receiving registration information from the application in response to transmitting the request to install the application.

13. The method according to claim 11, further comprising generating the request to install the application, wherein the request to install the application is configured to cause an alert to appear on the mobile device.

14. The method according to claim 12, wherein transmitting the request to implement the performance test comprises transmitting the request to implement the performance test in response to receiving the registration information.

15. The method according to claim 10, further comprising generating the request to implement the performance test, wherein the request to implement the performance test is configured to cause the mobile device to display an alert to the user in response to receiving the request.

16. The method according to claim 10, wherein providing the recommendation comprises providing the recommendation for causing a map to appear on the mobile device, wherein the map includes a location of a store or repair shop.

17. The method according to claim 10, wherein providing the recommendation comprising providing the recommendation comprising directions to a store or repair shop.

18. The method according to claim 10, further comprising transmitting a repair request to maintenance personnel based on the received results of the performance test.

19. A non-transitory computer readable medium storing instructions thereon, wherein the instructions, when executed by a processor, are configured to cause the processor to:
receive an inquiry from a user having access to a mobile device;
determine whether the system is able to access an application on the mobile device;
transmit a request to implement a performance test to the application in response to determining the system is able to access the application;
receive results of the performance test; and
provide a recommendation for addressing the inquiry from the user based on the received results of the performance test.

20. The non-transitory computer readable medium according to claim 19, wherein the instructions are configured to cause the processor to execute transmit a request to install the application to the mobile device in response to determining the system is unable to access the application.
